(19) United States
(12) Patent Application Publication
(10) Pub. No.: US 2020/0151809 A1
(43) Pub. Date: May 14, 2020

(54) ON-LINE AUCTION METHOD, ON-LINE AUCTION SYSTEM, AND COMPUTER PROGRAM STORED IN COMPUTER-READABLE MEDIUM THAT USE WEBSOCKET COMMUNICATION

(71) Applicant: SEOUL AUCTION BLUE, Seoul (KR)

(72) Inventor: Jung Bong LEE, Gyeonggi-do (KR)

(73) Assignee: SEOUL AUCTION BLUE, Seoul (KR)

(21) Appl. No.: 16/615,388

(22) PCT Filed: May 28, 2018
(86) PCT No.: PCT/KR2018/006039

§ 371 Date: Nov. 20, 2019

(30) Foreign Application Priority Data
May 31, 2017 (KR) 10-2017-0067772

(51) Int. Cl. G06Q 30/08; G06Q 20/12; G06F 16/25; H04L 29/08

(52) U.S. Cl. CPC G06Q 30/08; H04L 67/02; G06F 16/252; G06Q 20/127

(57) ABSTRACT

An online auction method includes: receiving login request signals from a plurality of user terminals, maintaining a connection between each of the user terminals and the messenger server, and transmitting and receiving basic data for an online auction to and from each of the user terminals; receiving first data for a bid from a first user terminal and storing the first data in the auction database; transmitting second data including all or part of the first data to the messenger server; transmitting third data including all or part of the second data to the user terminals; transmitting fourth data for an auction termination request to the auction server at a preset time; transmitting fifth data including all or part of the fourth data to the messenger server; transmitting sixth data for terminating the auction to the user terminals; and terminating the auction by the auction server.

### TECHNICAL FIELD

The present disclosure relates to an online auction method, an online auction system, and a computer program stored in a computer readable medium that use WebSocket communication.

### BACKGROUND ART

Polling is a method of handling request-response between a server and a client terminal in an Internet-based network environment. Specifically, polling is a scheme in which a typical client terminal such as a personal computer (PC) periodically accesses a server to make a request and receives a result corresponding to the request from the server. In the polling scheme, the client terminal accesses the server and checks the status of the server, data, or an event. Accordingly, when there is a change in status or data in the server, the client terminal may not recognize the change until it receives the change in the status or data by accessing the server and making a request. In addition, in such a general polling scheme, a request and a response are periodically generated, and therefore traffic may be wasted.

Long polling is an enhanced version of the aforementioned polling scheme. In this scheme, when the client terminal makes a request to the server, the serve waits until an event is updated, and then sends a response to the client terminal only when the event is triggered. However, the long polling scheme may cause a heavy load to the server if the number of client terminals increases and thus request queues are accumulated.

In a streaming scheme, a web connection is maintained for a request from a client terminal, and the server sends a partial response to the client terminal whenever a new event is triggered in the server.

When a client terminal and a server exchange data with each other in an Internet based network environment using the schemes as mentioned above, various services such as Internet banking, web surfing, and chat can be provided. However, such schemes raise the above-mentioned issues, that is, non-real-time recognition and increase in traffic. In particular, when a service such as an online auction is implemented based on the polling or long polling scheme described above, it is difficult to establish accurate synchronization among all client terminals participating in the online auction in terms of the status of the server, i.e., the data in the server. In addition, due to the nature of online auctions, traffic may be congested when there are many auction participants. Such technical issues may cause different auction bid prices to be displayed on the terminals participating in an online auction, thereby making acute competitive bidding impossible at the final stage of the auction.

Background technology of the present disclosure is disclosed in Korean Patent Application Publication No. 10-2016-0120412 (Oct. 18, 2016).

### DISCLOSURE

### Technical Problem

It is an object of the present disclosure to provide an online auction method using WebSocket communication.

It is another object of the present disclosure to provide an online auction system using WebSocket communication.

### Technical Solution

In accordance with one aspect of the present disclosure, provided is an online auction method using WebSocket communication and including a messenger server, an auction server, a time server, and an auction database containing data about an auction start price, an auction termination time, and an auction, the method including: receiving, by the messenger server, login request signals from a plurality of user terminals through the WebSocket communication, maintaining a connection between each of the user terminals and the messenger server, and transmitting and receiving basic data for an online auction to and from each of the user terminals; receiving, by the auction server, first data for a bid from a first user terminal and storing the first data in the auction database; transmitting, by the auction server, second data including all or part of the first data to the messenger server; transmitting, by the messenger server, third data including all or part of the second data to the user terminals through the WebSocket communication; transmitting, by the time server, fourth data for an auction termination request to the auction server at a preset time; transmitting, by the auction server, fifth data including all or part of the fourth data to the messenger server; transmitting, by the messenger server, sixth data for terminating the auction to the user terminals through the WebSocket communication; and terminating the auction by the auction server.

In accordance with another aspect of the present disclosure, provided is an online auction method using WebSocket communication and including a messenger server, an auction server, a time server, a web server, and an auction database containing data about an auction start price and an auction termination time, the method including: receiving, by the web server, data for an auction request from a plurality of user terminals and transmitting response data corresponding thereto; maintaining, by the messenger server, connection between the plurality of user terminals and the messenger server through the WebSocket communication; receiving, by the web server, eleventh data for a bid from a first user terminal and retransmitting twelfth data including all or part of the eleventh data to the auction server; storing, by the auction server, all or part of the twelfth data in the auction database; transmitting, by the auction server, thirteenth data including all or part of the twelfth data to the messenger server; transmitting, by the messenger server, fourteenth data including all or part of the thirteenth data to the user terminals through the WebSocket communication; transmitting, by the time server, fifteenth data for an auction termination request to the auction server at a preset time; transmitting, by the auction server, sixteenth data including all or part of the fifteenth data to the messenger server; transmitting, by the messenger server, seventeenth data for termination of an auction to the user terminals through the WebSocket communication; and terminating the auction by the auction server.

In accordance with another aspect of the present disclosure, provided is an online auction method using WebSocket communication and including a messenger server, an auction server, a time server, an automatic bidding server, and an auction database containing data about an auction start price and an auction termination time, the method including: receiving, by the messenger server, login request signals from a plurality of user terminals through the WebSocket communication, maintaining a connection between each of the user terminals and the messenger server, and transmitting and receiving basic data for an online auction to and from each of the user terminals; receiving, by the automatic bidding server, twenty-first data for automatic bidding from a first user terminal and storing the data in the auction database; receiving, by the auction server, twenty-second data including part of the twenty-first data for a bid from the automatic bidding server and storing the same in the auction database; transmitting, by the auction server, twenty-third data including all or part of the twenty-second data to the messenger server; transmitting, by the messenger server, twenty-fourth data including all or part of the twenty-third data to the user terminals through the WebSocket communication; transmitting, by the time server, twenty-fifth data for an auction termination request to the auction server at a preset time; transmitting, by the auction server, twenty-sixth data including all or part of the twenty-fifth data to the messenger server at a preset time; transmitting, by the messenger server, twenty-seventh data for termination of an auction to the user terminals through the WebSocket communication; and terminating the auction by the auction server.

When the auction server receives data for a bid from a second user terminal, the automatic bidding server may transmit the data for the bid to the auction server according to a set value included in a range of the twenty-first data.

The method may further include: when the auction server receives data for a bid from a user terminal within a preset auction termination preparation time, extending, by the auction server, the auction termination time by a first time; and transmitting, by the auction server, data about the auction termination time extended by a second time to the time server, wherein the first time may be longer than the second time.

In accordance with another aspect of the present disclosure, provided is an online auction system using WebSocket communication, the system including a messenger server, an auction server, a time server, and an auction database containing data about an auction start price and an auction termination time, wherein the auction server may be configured to receive first data for a bid from a first user terminal and store the data in the auction database; transmit second data including all or part of the first data to the messenger server, and transmit fifth data including all or part of fourth data for an auction termination request received from the time server to the messenger server, and check the fourth data to terminate an auction, wherein the messenger server may be configured to perform, through the WebSocket communication, operations of receiving login request signals from a plurality of user terminals and maintaining a connection between each of the user terminals and the messenger server; transmitting and receiving basic data for an online auction to and from each of the user terminals; transmitting third data including all or part of the second data to the user terminals; and transmitting sixth data for termination of the auction to the user terminals, wherein the time server may be configured to transmit fourth data for an auction termination request to the auction server at a preset time, and wherein the auction database may be configured to store data according to progress of the auction.

In accordance with another aspect of the present disclosure, provided is an online auction system using a WebSocket communication, the system including a messenger server, an auction server, a time server, a web server, and an auction database configured to store data related to an auction, wherein the auction server may be configured to receiving first data for a bid from a first user terminal and store the first data in the auction database, transmit second data including all or part of the first data to the messenger server, and transmit fifth data including all or part of fourth data for an auction termination request received from the time server to the messenger server, and check the fourth data to terminate an auction, wherein the web server may be configured to receive requests for a bid from a plurality of user terminals based on Hypertext Transfer Protocol (http) or Hypertext Transfer Protocol over Secure Socket Layer (https) and transmit response data including basic data for an online auction to the user terminals, wherein the messenger server may be configured to maintain a connection between each of the user terminals and the messenger server through the WebSocket communication, transmit third data including all or part of the second data to the user terminals through the WebSocket communication, and transmit sixth data for termination of the auction to the user terminals through the WebSocket communication, wherein the time server may be configured to transmit fourth data for an auction termination request to the auction server at a preset time, and wherein the auction database may be configured to store data according to progress of the auction.

The system may further include an automatic bidding server configured to receive twenty-first data for automatic bidding from the first user terminal and store the received data in the auction database, wherein, when the auction server receives data for a bid from a second user terminal, the automatic bidding server may transmit the data for the bid to the auction server according to a set value included in a range of the twenty-first data.

In addition, when the auction server receives data for a bid from a user terminal within a preset auction termination preparation time, the auction server may extend the auction termination time by a first time, and transmit data about the auction termination time extended by a second time to the time server, wherein the first time may be longer than the second time.

In accordance with another aspect of the present disclosure, provided is an online auction system using WebSocket communication, the system including a messenger server, an auction server, a time server, and an auction database containing data about an auction start price and an auction termination time, wherein the auction server may be configured to receive first data for a bid from a first user terminal and store the data in the auction database, transmit second data including all or part of the first data to the messenger server, and transmit fifth data including all or part of fourth data for an auction termination request received from the time server to the messenger server, and check the fourth data to terminate an auction, wherein the messenger server may be configured to receive login request signals from a plurality of user terminals and maintain a connection between each of the user terminals and the messenger server, transmit and receive basic data for an online auction to and from each of the user terminals, transmit third data including all or part of the second data to the user terminals, and transmit sixth data for termination of the auction to the user terminals, wherein the time server may be configured to transmit fourth data for an auction termination request to the auction server at a preset time, and wherein the auction database may be configured to store data according to progress of the auction, wherein the messenger server may transmit and receive data to and from the user terminals through the WebSocket communication only when the auction system receives a login request from the user terminals or a terminal presumed to be a terminal of a specific user is connected to the online auction system.

In accordance with another aspect of the present disclosure, provided is a computer program included in a recording medium for executing the operations included in the method.

### Advantageous Effects

According to an aspect of the present disclosure, an online auction method using WebSocket communication may be provided.

According to another aspect of the present disclosure, an online auction system using WebSocket communication may be provided.

### DESCRIPTION OF DRAWINGS

FIG. 1 is a block diagram of an online auction system according to an embodiment of the present disclosure.

FIG. 2 shows a configuration of a system according to another embodiment of the present disclosure.

FIG. 3 is a diagram illustrating a procedure of an online auction method according to an embodiment of the present disclosure.

FIG. 4 is a diagram illustrating a procedure of an online auction method according to another embodiment of the present disclosure.

FIG. 5 is a diagram illustrating a procedure of an online auction method according to another embodiment of the present disclosure.

### BEST MODE

As the present disclosure allows for various changes and numerous embodiments, particular embodiments will be illustrated in the drawings and described in detail in the following description. However, this is not intended to limit the present disclosure to specific embodiments, but is intended to cover all modifications, equivalents, and substitutes within the spirit and scope of the present disclosure. In the following description of the present disclosure, a detailed description of related known technology may be omitted to avoid obscuring the gist of the present disclosure.

Terms such as first and second may be used in describing various components, but the components should not be limited by the terms. The terms are used only for the purpose of distinguishing one component from another.

Terms used in this specification are merely adopted to explain specific embodiments, and are not intended to limit the present disclosure. A singular expression includes a plural expression unless the two expressions are contextually different from each other. In this specification, the term “include” or “have” is intended to indicate that characteristics, figures, steps, operations, constituents, and components disclosed in the specification or combinations thereof exist. The term “include” or “have” should be understood as not pre-excluding possibility of existence or addition of one or more other characteristics, figures, steps, operations, constituents, components, or combinations thereof.

### REFERENCE NUMERALS

10: Online auction system
10m: Auction server
20n: Messenger server
300: Time server
400: Automatic bidding server
500: Web server
600: Auction information storage

### MODE FOR INVENTION

Hereinafter, embodiments according to the present disclosure will be described in detail with reference to the accompanying drawings. In the following description with reference to the accompanying drawings, the same or like components are given the same reference numerals and redundant description thereof will be omitted.

In addition, terms such as first and second used below are merely identification symbols for distinguishing the same or corresponding components, and the same or corresponding components are not limited by the terms such as first and second.

In addition, the term combination will be used as a concept covering not only a direct physical contact between the components, but also a contact between components with another component interposed therebetween in terms of the contact relationship between the components.

Regarding a computer program, the suffixes “module” and/or “unit” for a component may be a part of a computer program for operating the computer as a means of a specific function, or may be a part of a computer program for realizing a specific function in the computer. For example, module A can be interpreted as a computer program for operating the computer as means A or a computer program for realizing function A in the computer. In a method, a “step” may be implemented as a computer program on a computer and executed. In addition, “modules” and/or “units” may be combined to form a “group”.

An application refers to a set of computer programs designed to perform a specific task, and is also called an application program. A user may add related functions by installing an application according to an embodiment of the present disclosure on his or her electronic device.

An electronic device of the user on which the application is installed is composed of CPU, RAM, ROM, and a storage device as in a computer, a tablet, and a smartphone, and may be provided with an environment in which the entire system is controlled through a graphical operating system such as Windows, iOS, Android, and Linux. In particular, the environment is specialized for smartphones capable of sending and receiving calls and texts by registered contacts.

The flowcharts in the drawings attached herein are merely for explanation of the disclosure, and are not necessarily flowcharts to be perfectly implemented without a bug on a computer.

A terminal mentioned herein may be a typical user terminal such as a smartphone, a personal computer, or a tablet.

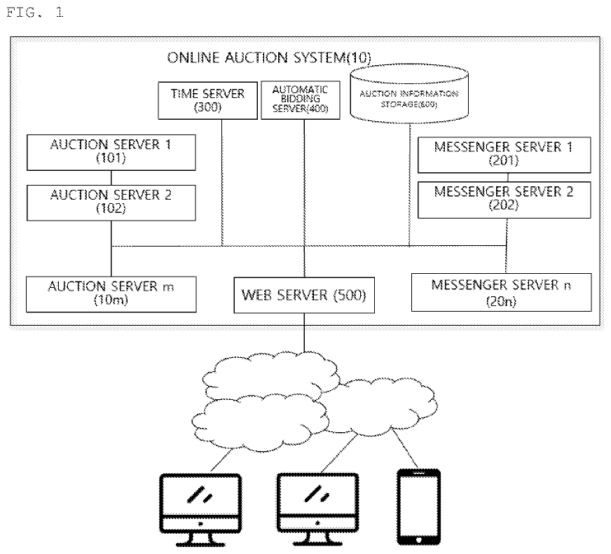

FIG. 1 is a block diagram of an online auction system according to an embodiment of the present disclosure. Referring to FIG. 1, the online auction system 10 may include one or more auction servers 10m, one or more messenger servers 20m, a time server 300, an automatic bidding server 400, a web server 500, and an auction information storage 600.

First, the auction server performs overall operations for online auction. More specifically, the auction server serves to receive data for a bid from user terminals, store the data in the auction database, transmit the received data for the bid to the messenger server, and cause an auction termination request signal received from the time server to be broadcast to the user terminals. For example, the server may operate to receive input bid data from a user terminal, to change the data to the highest bidding price, and to terminate, when the condition for terminating the auction is satisfied, the auction and broadcast the termination to the user terminal through the messenger server. All the operations that occur during this process are recorded on the auction information storage so as to remain as a log. In addition, when an auction termination condition (e.g., imminence of the auction termination time) is triggered, the auction server performs a corresponding operation. For example, when bidding occurs near the auction termination time (e.g., within 30 seconds of auction termination), the server performs a corresponding operation (e.g., extending the auction termination time by 30 seconds).

When bidding occurs near the auction termination time, the auction server is close to the auction end, and when a bid occurs, a signal may be sent to the time server to extend the termination time by a time shorter than the extension time. More specifically, when bidding occurs near the auction termination time, the auction server postpones auction termination on the assumption that more bidding may occur. For example, when the auction is set to be terminated at 13:00:00 on May 1, 2017, the auction server prepares for the auction termination procedure from a time exceeding 12:59:30. In this case, when a bid occurs at 12:59:40 on May 1, 2017, the auction server automatically adds 30 seconds to the auction time. More specifically, 30 seconds is added to the auction time such that the auction termination time becomes 13:00:20 on May 1, 2017.

Thereafter or at the same time, the auction server informs the time server that more auction time is available. Here, a time shorter than 30 seconds is added to the auction time as described above. Because it takes time for processing for the auction server to inform the time server of extension of the auction time due to the load issue on the server or the network, a shorter time is transmitted to the time server. For example, the time server may be informed that 29 more seconds have been allotted.

In addition, instead of announcing extended relative bid time, the auction server may inform the time server of the auction termination time. In more detail, unlike the foregoing description, when bidding occurs near the auction termination time, the auction server may transmit, to the time server, a predetermined value indicating that the auction termination time is 13:00:20 on May 1, 2017. Then, when the time server receives a new auction termination time, it transmits an auction termination request signal to the auction server at 13:00:20 on May 1, 2017 such that the auction server terminates the auction.

There may be a plurality of auction servers in the online auction system. Terminals are allocated such that the terminals perform bidding on an appropriate auction server according to the load relationship between the auction servers.

In addition, the auction server performs an operation for a typical online auction, and details thereof are omitted.

Next, the messenger server performs overall operations for communication between a terminal bidding in the auction and the online auction system. More specifically, the messenger server serves to maintain a connection between each of a plurality of user terminals and the messenger server and broadcast data about the auction progress, imminence of auction termination, and auction termination to the terminals according to bidding of each terminal. Here, the messenger server and the terminals are connected by WebSocket communication. Thereby, the user terminals may communicate with the messenger server in real time, and thus the user terminals may check changed auction-related data on the online auction system without delay.

The messenger server does not need to perform WebSocket communication for all user terminals, and may perform WebSocket communication for some specific user terminals. For example, the messenger server may perform WebSocket-based communication with only user terminals logged into the online auction system, and may communicate with the remaining terminals based on the conventional polling scheme. This is because the remaining terminals are not logged in, and may be determined to be potentially less likely to participate in the auction.

In addition, whether to perform WebSocket communication may be determined by analyzing the pattern or auction data of the user terminal for the online auction system. For example, in an auction starting from a relatively low bidding price, 1,000 won, when an expected final contract price is expected to be 100,000 won, which is relatively low, the server may communicate with a bidding terminal according to a conventional communication scheme rather than the WebSocket scheme depending on the network load of the online auction system in various cases including a case where the regional location of the bidding terminal is in the same continent as the server, and a case where the number of nodes on a network between the terminal and the online auction system is less than or equal to 5.

In addition, when the number of auction items that the user terminal has won in the past is greater than or equal to a specific number or the bidding price is a relatively high price, such as 10 million won, a control operation may be performed to make communication between the online auction system and the user terminal basically performed on the basis of WebSocket to ensure a real-time online auction.

In addition, it is assumed that several online auctions are in progress in view of the online auction system. In this case, WebSocket communication may be performed with user terminals for a specific online auction, and other types of communication may be performed for the remaining online auctions within the same online auction system, based on the scale of the bidding price, the number of bidders, the locations of bidding user terminals (e.g., connection of user terminals which are from different continents and assigned IP addresses allocated to the different continents), or presetting of the online auction system administrator (e.g., setting that a certain online auction is to be performed in the polling scheme).

As such, the messenger server may effectively perform network load balancing by coordinating the communication schemes for the user terminals and the online auction system.

Next, the web server serves to receive requests for bidding from a plurality of user terminals based on Hypertext Transfer Protocol (http) or Hypertext Transfer Protocol over Secure Socket Layer (https) and transmit response data including basic data for an online auction to the user terminals. More specifically, when a user terminal approaches, the web server delivers a general file necessary for an online auction to the user terminal. The web server transmits an image and text related to an auction item, and also manages a user terminal logging into the online auction system. Detailed description thereof will be omitted as well-known technology.

Next, the time server serves to transmit data for an auction termination request to the auction server at a preset time. More specifically, the time server serves to send a request signal for termination of auctions to the auction server at a specific time determined for each online auction. For example, when data indicating that an online auction of Goryeo porcelain is terminated at 13:00:00 on May 1, 2017 and an online auction of Joseon white porcelain is terminated at 14:00:00 on May 1, 2017 is input to the auction information storage and auctions are scheduled on the time server based thereon, the time server transmits a request signal for termination of the auctions to the respective auction servers at 13:00:00 on May 1, 2017 and 14:00:00 on May 1, 2017. Of course, the auction servers do not need to be logically or physically separated.

The time server may transmit an auction termination request signal to an auction server, and receive a response from the auction server to change the auction termination time. More specifically, when the time server has sent an auction termination request to the auction server, but the auction termination time is extended in the auction server, corresponding data is transmitted to the time server. The time server may then send the auction termination request signal to the auction server again at the delayed auction termination time, and the auction server may terminate the auction in response.

When the time server is physically located in one auction server, another auction server at a different location from the auction server may terminate the auction at a different time depending on the load on the network or performance of the equipment. However, in the present disclosure, by physically separating the time server from the auction servers or the like, the auction may be accurately terminated without an error in termination time among the auction servers even if the auction servers are physically located far apart from each other. When an online auction is held globally, the auction may be terminated at the accurate time by configuring the time server as described above.

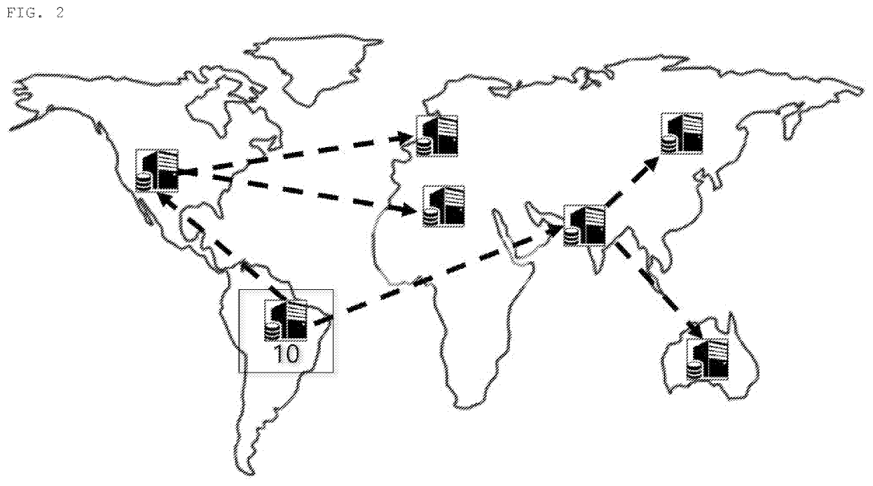

FIG. 2 shows a configuration of a system according to another embodiment of the present disclosure. Referring to FIG. 2, time servers are linked in multiple stages as a whole. Thus, a head time server, which provides an auction termination time, may be positioned at the top, and time servers connected to an auction server may be positioned at the bottom and controlled. In addition, by placing a time server for each continent, an auction termination delay according to the status of the network may be reduced even when users from different continents participate in an online auction.

Next, the automatic bidding server performs bidding on behalf of the user terminals. More specifically, when the auction server receives data for bidding from a user terminal, it may transmit the data for bidding to the auction server according to a set value included in the data range. The user terminal may transmit data or conditions for bidding such as an initial bidding price, the maximum bidding price, a bidding unit, and a waiting bidding time to the automatic bidding server. For example, for an auction with a starting auction price of one million won, the user generates a signal and transmits the signal to the automatic bidding server through the user terminal. The signal indicates that the initial bidding price is 1.1 million won, the bid is raised to a maximum of five million won in increments of 100,000 won, a bid of a third party should be made 25 seconds after triggering of the bid of the third party, and if there is a bid of a third party within 5 minutes before the termination of the auction, the bid should be made 10 seconds after triggering of the bid. The automatic bidding server participates in bidding on behalf of the user terminal based on the signal. For example, when a third user terminal bids at a bidding price of 1.5 million won, the automatic bidding server may transmit a bidding price of 1.6 million won to the auction server on behalf of the user terminal 25 seconds after bidding of the third user terminal.

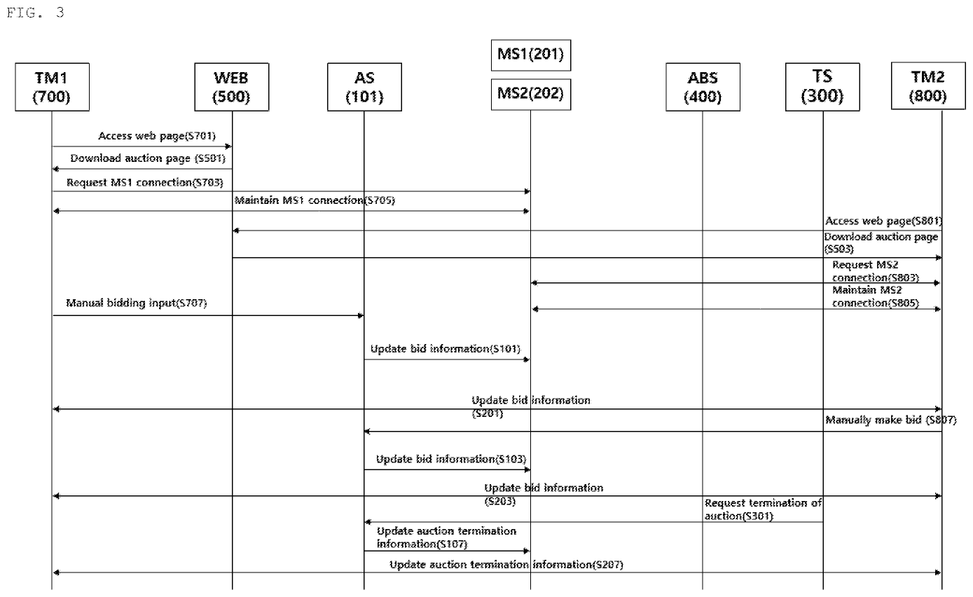

FIG. 3 is a diagram illustrating a procedure of an online auction method according to an embodiment of the present disclosure. Description of elements already described with reference to FIGS. 1 and 2 will be omitted.

Referring to FIG. 3, user terminal 1 (TM1) 700 accesses a web server (WEB) 500 (S701) and downloads a page about an auction (S501). In this process, the user terminal may log into the web server. Thereafter, TM1 may maintain connection with messenger server 1 (MS1) 201 based on WebSocket (S703 and S705). Similarly, user terminal 2 (TM2) 800 accesses the web server and performs the same operation (S801 and S503). TM2 also maintains connection with messenger server 2 (MS2) 202 based on WebSocket (S803 and 805). In this case, TM1 and TM2 do not need to be connected to MS1 and MS2, and a messenger server to which a user terminal is connected may be changed depending on the load on the messenger server. So far, the process of accessing and maintaining a connection between the user terminals and the online auction system has been described. Hereinafter, the online auction process will be discussed in detail.

The bid data input by TM1 is transmitted to the auction server (AS) 101 (S707). The bid data may include information about a bidding price. The auction server may store the bid data in the auction information storage. The data stored by the auction server may include various kinds of information such as a bidding price, identification information about a bidding terminal (e.g., ID of a person participating in the auction), and a bidding time. Then, the auction server processes the bid data again and transmits the processed data to the messenger server (S101). The messenger server updates the information by sending the bid information to all connected user terminals (S201). Since the messenger server and the user terminals are connected on a WebSocket basis, the user terminals may receive the bid information in real time without making a request to check whether the messenger server has a new bid. Thereafter, TM2 newly transmits bid data to the auction server (S807), and the auction server processes the data for the bid as described above and transmits the processed data to the messenger server (S103). The messenger server updates the bid information in all the user terminals (S203). So far, the bidding process has been described. Hereinafter, an online auction termination process will be discussed.

When the auction termination time is reached, the time server 300 transmits a control signal for terminating the auction to the auction server (S301). Then, the auction server performs the auction termination procedure, which includes terminating the auction and confirming the successful bidder, such that no more bids are made. Thereafter, the auction server transmits auction termination information (e.g., a successful bid price, a successful bidder ID, an auction termination time) to the messenger server (S107). Thereafter, the messenger server transmits data about auction termination to each user terminal (S207).

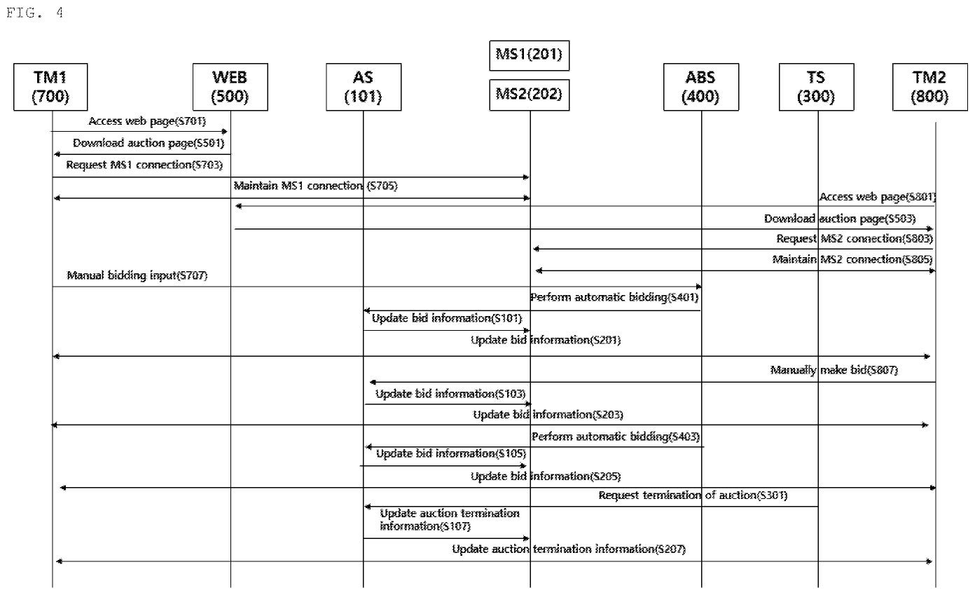

FIG. 4 is a diagram illustrating a procedure of an online auction method according to another embodiment of the present disclosure. Description of elements already described with reference to FIGS. 1 to 3 will be omitted. FIG. 4 illustrates a procedure of automatic bidding.

Referring to FIG. 4, TM1 transmits data about automatic bidding to the automatic bidding server (ABS) 400 (S707). Then, the automatic bidding server transmits data for bidding to the auction server 101 based on the received data (S401). Then, the auction server transmits data indicating the bidding to the messenger server as in FIG. 3 (S101). In turn, the messenger server transmits the bid information to all user terminals (S201). The operation is performed even if the user terminal having input the automatic bidding data is not connected to the online auction system.

As such, using the automatic bidding server, the user terminal may participate in an auction under a predetermined condition without missing the auction.

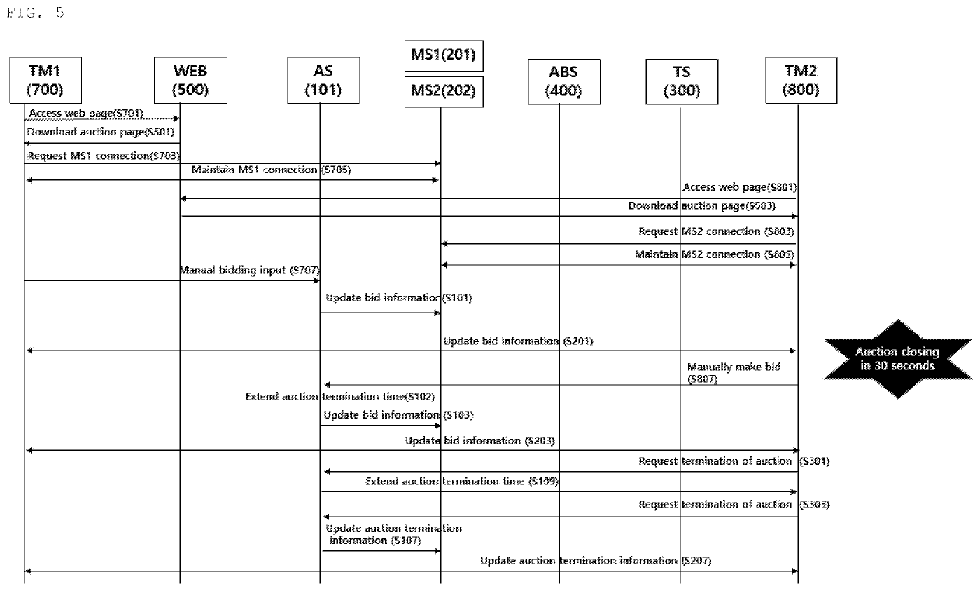

FIG. 5 is a diagram illustrating a procedure of an online auction method according to another embodiment of the present disclosure. Description of elements already described with reference to FIGS. 1 to 4 will be omitted. FIG. 5 illustrates a procedure of changing an auction termination time.

Referring to FIG. 5, a new bid is triggered within seconds before termination of an auction (S807). Accordingly, the auction server does not terminate the auction at a preset auction termination time, but extends the auction termination time as a new bid is triggered near the termination time (S102). Thereafter, the auction server transmits, to the messenger server, an indication that a new bid has been triggered and the auction termination time has been extended (S103). The messenger server updates the bid information in the user terminal (S203).

Thereafter, when the preset auction termination time is reached, the time server makes a request for termination of the auction to the auction server (S301). However, the auction server does not terminate the auction because the auction server has reset the auction termination time by extending the auction termination time by a preset time based on the condition that a new bid has been triggered within a preset time from the auction termination time. Instead, the auction server transmits, to the time server, a signal indicating that the auction termination time is extended (S109). Thereafter, the time server resets the auction termination time, and makes a request for termination of the auction to the auction server again when the reset termination time is reached (S303). Thereafter, the auction server finally sends a signal indicating termination of the auction to the messenger server and updates the information in all user terminals through the signal (S207).

In the conventional polling scheme, when there is a new bid through another user terminal during the time when a user terminal does not access the auction server, the new bid is not reflected in the user terminal. As a result, the auction may be terminated while a user terminal that has generated bid data immediately before the final bid does not recognize the new bid. On the other hand, in the present disclosure, since the WebSocket communication scheme is used, when there is a new bid at a time near closing of the auction, it may update the user terminal in real time with the information that there is a new bid, change the auction termination time, and cause the auction termination request to be made according to the changed auction termination time through the time server. Thereby, all user terminals participating in the auction may be allowed to experience the auction termination at the same auction termination time.

The method and processing described above are instructions to be executed by, for example, a processor, a controller, or other processing devices and may be encoded or stored in a compact disk read-only memory (CD-ROM), a magnetic disk, an optical disc, a flash memory, a random access memory (RAM) or read only memory (ROM), an erasable programmable read only memory (EPROM), or other machine-readable or computer-readable media.

Such a medium may be implemented by an instruction executable system, apparatus, or device, or any device that contains, stores, communicates, propagates, or moves executable instructions for use in connection therewith. Alternatively or additionally, the method and processing may be implemented by analog or digital logic using hardware such as one or more integrated circuits, or one or more processor executable instructions; or by software of functions defined as an application programming interface (API), a dynamic link library (DLL), a local or remote procedure call or available in a shared memory; or by a combination of hardware and software.

In other implementations, the method may be represented by a signal or radio-signal medium. For example, the instructions for implementing the logic of any given program may take the form of an electrical, magnetic, optical, electromagnetic, infrared or other type of signal. The system described above may receive these signals through a communication interface, such as a fiber optic interface, an antenna, or another analog or digital signal interface, restore instructions from the signals, store the instructions in a machine-readable memory, and/or execute the same using a processor.

In addition, the present invention may be implemented in hardware or software. The invention may also be implemented as computer-readable code on a computer-readable recording medium. The computer-readable recording medium includes all kinds of recording devices in which data that may be read by a computer system is stored. Examples of computer-readable recording media include ROM, RAM, CD-ROM, magnetic tapes, floppy disks, and optical data storage devices, and also include carrier-wave type implementation (e.g., transmission over the Internet). The computer-readable recording medium may be distributed to a computer system connected over a network, and computer-readable code may be stored and executed thereon in a distributed manner. Functional programs, code, and code segments for implementing the method described above may be easily inferred by programmers in the art to which the embodiments pertain.

Embodiments of the present disclosure may include a carrier wave having electronically readable control signals that may be operated with a programmable computer system on which one of the methods described herein is executed. Embodiments of the disclosure may be implemented as a computer program product having program code, the program code being operated to execute one of the methods when the computer program is run on a computer. The program code may be stored on, for example, a machine-readable carrier. One embodiment of the disclosure may be a computer program having program code for executing one of the methods described herein when the computer program is run on a computer. The disclosure may include a computer or a programmable logic device for performing one of the methods described above. Programmable logic devices (e.g., field programmable gate arrays, complementary metal oxide semiconductor based logic circuits) may be used to perform some or all of the functions described above.

Although an embodiment of the present disclosure has been described above, it is apparent to those skilled in the art that various modifications and changes can be made to the present disclosure by adding, changing, or deleting components within the scope not departing from the spirit of the present disclosure as set forth in the claims. Such modifications and changes are also within the scope of the present disclosure.

### INDUSTRIAL APPLICABILITY

The present disclosure may be utilized for real-time online auctions, such as an online auction method and an online auction system that use WebSocket communication.

1. An online auction method using WebSocket communication and including a messenger server, an auction server, a time server, and an auction database containing data about an auction start price, an auction termination time, and an auction, the method comprising:
receiving, by the messenger server, login request signals from a plurality of user terminals through the WebSocket communication, maintaining a connection between each of the user terminals and the messenger server, and transmitting and receiving basic data for an online auction to and from each of the user terminals;
receiving, by the auction server, first data for a bid from a first user terminal and storing the first data in the auction database;
transmitting, by the auction server, second data including all or part of the first data to the messenger server;
transmitting, by the messenger server, third data including all or part of the second data to the user terminals through the WebSocket communication;
transmitting, by the time server, fourth data for an auction termination request to the auction server at a preset time;
transmitting, by the auction server, fifth data including all or part of the fourth data to the messenger server;
transmitting, by the messenger server, sixth data for terminating the auction to the user terminals through the WebSocket communication; and
terminating the auction by the auction server.

2. An online auction method using WebSocket communication and including a messenger server, an auction server, a time server, a web server, and an auction database containing data about an auction start price and an auction termination time, the method comprising:
receiving, by the web server, data for an auction request from a plurality of user terminals and transmitting response data corresponding thereto;
maintaining, by the messenger server, connection between the plurality of user terminals and the messenger server through the WebSocket communication;
receiving, by the web server, eleventh data for a bid from a first user terminal and retransmitting twelfth data including all or part of the eleventh data to the auction server;
storing, by the auction server, all or part of the twelfth data in the auction database;
transmitting, by the auction server, thirteenth data including all or part of the twelfth data to the messenger server;
transmitting, by the messenger server, fourteenth data including all or part of the thirteenth data to the user terminals through the WebSocket communication;
transmitting, by the time server, fifteenth data for an auction termination request to the auction server at a preset time;
transmitting, by the auction server, sixteenth data including all or part of the fifteenth data to the messenger server;
transmitting, by the messenger server, seventeenth data for termination of an auction to the user terminals through the WebSocket communication; and
terminating the auction by the auction server.

3. An online auction method using WebSocket communication and including a messenger server, an auction server, a time server, an automatic bidding server, and an auction database containing data about an auction start price and an auction termination time, the method comprising:
receiving, by the messenger server, login request signals from a plurality of user terminals through the WebSocket communication, maintaining a connection between each of the user terminals and the messenger server, and transmitting and receiving basic data for an online auction to and from each of the user terminals;
receiving, by the automatic bidding server, twenty-first data for automatic bidding from a first user terminal and storing the data in the auction database;
receiving, by the auction server, twenty-second data including part of the twenty-first data for a bid from the automatic bidding server and storing the same in the auction database;
transmitting, by the auction server, twenty-third data including all or part of the twenty-second data to the messenger server;
transmitting, by the messenger server, twenty-fourth data including all or part of the twenty-third data to the user terminals through the WebSocket communication;
transmitting, by the time server, twenty-fifth data for an auction termination request to the auction server at a preset time;
transmitting, by the auction server, twenty-sixth data including all or part of the twenty-fifth data to the messenger server at a preset time;
transmitting, by the messenger server, twenty-seventh data for termination of an auction to the user terminals through the WebSocket communication; and
terminating the auction by the auction server,
wherein, when the auction server receives data for a bid from a second user terminal, the automatic bidding server transmits the data for the bid to the auction server according to a set value included in a range of the twenty-first data.

4. The method of claim 1, further comprising:
when the auction server receives data for a bid from a user terminal within a preset auction termination preparation time, extending, by the auction server, the auction termination time by a first time; and
transmitting, by the auction server, data about the auction termination time extended by a second time to the time server,
wherein the first time is longer than the second time.

5. An online auction system using WebSocket communication, the system comprising a messenger server, an auction server, a time server, and an auction database containing data about an auction start price and an auction termination time,
wherein the auction server is configured to:
receive first data for a bid from a first user terminal and store the data in the auction database;
transmit second data including all or part of the first data to the messenger server; and
transmit fifth data including all or part of fourth data for an auction termination request received from the time server to the messenger server, and check the fourth data to terminate an auction,
wherein the messenger server is configured to perform, through the WebSocket communication, operations of:
receiving login request signals from a plurality of user terminals and maintaining a connection between each of the user terminals and the messenger server;
transmitting and receiving basic data for an online auction to and from each of the user terminals;
transmitting third data including all or part of the second data to the user terminals; and
transmitting sixth data for termination of the auction to the user terminals,
wherein the time server is configured to transmit fourth data for an auction termination request to the auction server at a preset time, and
wherein the auction database is configured to store data according to progress of the auction.

6. An online auction system using a WebSocket communication, the system comprising a messenger server, an auction server, a time server, a web server, and an auction database configured to store data related to an auction,
wherein the auction server is configured to:
receiving first data for a bid from a first user terminal and store the first data in the auction database;
transmit second data including all or part of the first data to the messenger server; and
transmit fifth data including all or part of fourth data for an auction termination request received from the time server to the messenger server, and check the fourth data to terminate an auction,
wherein the web server is configured to receive requests for a bid from a plurality of user terminals based on Hypertext Transfer Protocol (http) or Hypertext Transfer Protocol over Secure Socket Layer (https) and transmit response data including basic data for an online auction to the user terminals,
wherein the messenger server is configured to:
maintain a connection between each of the user terminals and the messenger server through the WebSocket communication;
transmit third data including all or part of the second data to the user terminals through the WebSocket communication; and
transmit sixth data for termination of the auction to the user terminals through the WebSocket communication,
wherein the time server is configured to transmit fourth data for an auction termination request to the auction server at a preset time, and
wherein the auction database is configured to store data according to progress of the auction.

7. The system of claim 5, further comprising an automatic bidding server configured to receive twenty-first data for automatic bidding from the first user terminal and store the received data in the auction database,
wherein, when the auction server receives data for a bid from a second user terminal, the automatic bidding server transmits the data for the bid to the auction server according to a set value included in a range of the twenty-first data.

8. The system of claim 5, wherein, when the auction server receives data for a bid from a user terminal within a preset auction termination preparation time, the auction server extends the auction termination time by a first time, and transmit data about the auction termination time extended by a second time to the time server,
wherein the first time is longer than the second time.

9. An online auction system using WebSocket communication, the system comprising a messenger server, an auction server, a time server, and an auction database containing data about an auction start price and an auction termination time,
wherein the auction server is configured to:
receive first data for a bid from a first user terminal and store the data in the auction database;
transmit second data including all or part of the first data to the messenger server; and
transmit fifth data including all or part of fourth data for an auction termination request received from the time server to the messenger server, and check the fourth data to terminate an auction,
wherein the messenger server is configured to:
receive login request signals from a plurality of user terminals and maintain a connection between each of the user terminals and the messenger server;
transmit and receive basic data for an online auction to and from each of the user terminals;
transmit third data including all or part of the second data to the user terminals; and
transmit sixth data for termination of the auction to the user terminals,
wherein the time server is configured to transmit fourth data for an auction termination request to the auction server at a preset time, and
wherein the auction database is configured to store data according to progress of the auction,
wherein the messenger server transmits and receives data to and from the user terminals through the WebSocket communication only when the auction system receives a login request from the user terminals or a terminal presumed to be a terminal of a specific user is connected to the online auction system.

10. A computer program included in a recording medium for executing the operations included in the method of claim 1.

11. The method of claim 2, further comprising:
when the auction server receives data for a bid from a user terminal within a preset auction termination preparation time, extending, by the auction server, the auction termination time by a first time; and
transmitting, by the auction server, data about the auction termination time extended by a second time to the time server,
wherein the first time is longer than the second time.

12. The method of claim 3, further comprising:
when the auction server receives data for a bid from a user terminal within a preset auction termination preparation time, extending, by the auction server, the auction termination time by a first time; and
transmitting, by the auction server, data about the auction termination time extended by a second time to the time server,
wherein the first time is longer than the second time.

13. The system of claim 6, further comprising an automatic bidding server configured to receive twenty-first data for automatic bidding from the first user terminal and store the received data in the auction database,
wherein, when the auction server receives data for a bid from a second user terminal, the automatic bidding server transmits the data for the bid to the auction server according to a set value included in a range of the twenty-first data.

14. The system of claim 6, wherein, when the auction server receives data for a bid from a user terminal within a preset auction termination preparation time, the auction server extends the auction termination time by a first time, and transmit data about the auction termination time extended by a second time to the time server,
wherein the first time is longer than the second time.

15. A computer program included in a recording medium for executing the operations included in the method of claim 2.

16. A computer program included in a recording medium for executing the operations included in the method of claim 3.

17. A computer program included in a recording medium for executing the operations included in the method of claim 4.
